(19) United States
(12) Patent Application Publication
(10) Pub. No.: US 2014/0133833 A1
(43) Pub. Date: May 15, 2014

(54) CREATING CUSTOMIZED DIGITAL ADVERTISEMENT FROM VIDEO AND/OR AN IMAGE ARRAY

(71) Applicants: Jason Sumler, Dallas, TX (US); Isreal Alpert, Dallas, TX (US)

(72) Inventors: Jason Sumler, Dallas, TX (US); Isreal Alpert, Dallas, TX (US)

(21) Appl. No.: 13/673,650

(22) Filed: Nov. 9, 2012

(51) Int. Cl. H04N 5/91

(52) U.S. Cl. CPC H04N 5/91
USPC 386/278

(57) ABSTRACT

Disclosed are a method and apparatus of creating a customized advertisement for a particular product. One example method of operation may include receiving product use information related to prior use of the product at an application server and receiving a digital video including footage of the particular product at the application server. The method may also include receiving generic product information related to manufacturer specifications of the product at the application server, processing the product use information, the digital video and the generic product information to create the customized advertisement and transmitting the customized advertisement to a remote computing device.

### TECHNICAL FIELD OF THE APPLICATION

This present disclosure relates to creating a customized video advertisement and/or array of digital images from raw video data, and more particularly, to converting the raw video data into images including customized layover data, user preferred insert data and rendering the integrated content as a new video and corresponding product advertisement.

### BACKGROUND OF THE APPLICATION

Conventionally, short customized product advertisements lack customized user input. In one example, a user may take a short video and may desire to have the video setup as a particular advertisement for a product or service (i.e., car sales, real estate sales, etc.).

Once a short video is obtained, the user must upload the video, edit the portions of the video that are shaky, blurry, and/or dark, and rely on complicated video editing programs to add or subtract word headings, audio track layovers, and other features prior to rendering the video for a final output. Also, the immediate availability of image data extracted from the raw video data is not readily obtainable. Furthermore, no data integration model offers a template for user approval/rejection of images, video, data inserts, and other third party data which may be useful for creating the customized advertisement.

### SUMMARY OF THE APPLICATION

One embodiment of the present application may include a method of creating a customized advertisement for a particular product. The method may include receiving product use information related to prior use of the product at an application server, receiving a digital video including footage of the particular product at the application server and receiving generic product information related to manufacturer specifications of the product at the application server. The method may also include processing the product use information, the digital video and the generic product information to create the customized advertisement, and transmitting the customized advertisement to a remote computing device.

Another example embodiment of the present invention may include an apparatus configured to create a customized advertisement for a particular product. The apparatus may include a receiver configured to receive product use information related to prior use of the product at an application server, receive a digital video including footage of the particular product at the application server, and receive generic product information related to manufacturer specifications of the product at the application server. The apparatus may also include a processor configured to process the product use information, the digital video and the generic product information to create the customized advertisement and a transmitter configured to transmit the customized advertisement to a remote computing device.

### BRIEF DESCRIPTION OF THE DRAWINGS

FIG. 1 illustrates an example video shoot of a user recording a full perspective video of an example product, according to example embodiments.

FIG. 2 illustrates an example communication network of video content being uploaded to a video processing server accessible by a user computing device.

FIG. 3 illustrates an example graphical user interface of the video processing application according to example embodiments.

FIG. 4 illustrates an example video processing system used to integrate the various data inputs associated with the example product, according to example embodiments.

FIG. 5A illustrates an example graphical user interface for customizing a video stream as an array of images according to example embodiments.

FIG. 5B illustrates the example graphical user interface of FIG. 5A for customizing a video stream as an array of images with an option to select a predefined number of pictures within a predefined time frame according to example embodiments.

FIG. 6 illustrates an example video timeline configured to receive data inserts at specified time insertion points according to example embodiments.

FIG. 7 illustrates an example single-entity or multiple entity system diagram that performs the various operations and features corresponding to the example embodiments.

FIG. 8A illustrates a flow diagram of an example method of operation according to example embodiments.

FIG. 8B illustrates another flow diagram of an example method of operation according to example embodiments.

FIG. 9 illustrates a network entity that may include memory, software code and other computer processing hardware used to perform various operations according to example embodiments.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

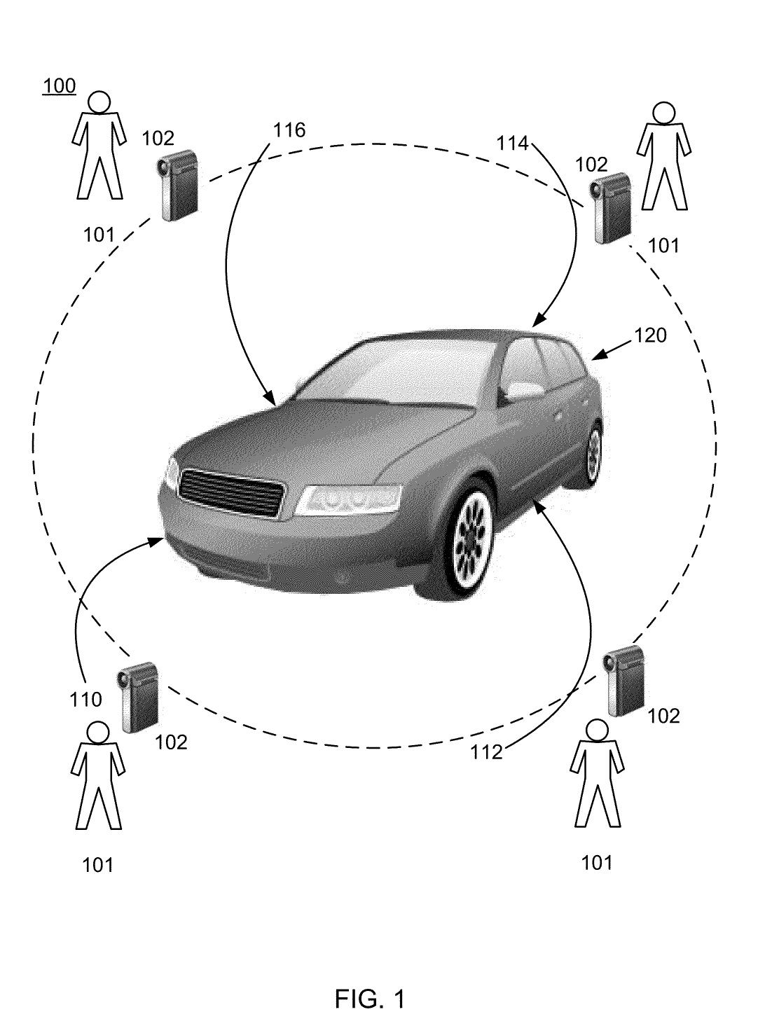

FIG. 1 illustrates an example video shoot of a user recording a full perspective video of an example product, according to example embodiments. Referring to FIG. 1, the example illustrated is a car as an example product type. However, it is hereby submitted that any product may be incorporated into the example embodiments that follow in the detailed description.

In FIG. 1, the digital video shoot 100 may include a user 101 operating a video camera 102. The user 101 may capture digital video from all angles of the motor vehicle 120, including the front 110, left 116, right 112, top 114, bottom, trunk, hood, interior, tires, engine, etc. The digital video may be recorded from a handheld camera, smartphone device, or other digital video recording device. The digital video content may be processed and stored as a digital video file (e.g., MPEG, AVI, FLV, MOV, etc.). The digital video file or ‘raw video’ may be transferred to an application processing device. The device may be a computer, laptop, mobile, wireless or cellular phone, a PDA, a tablet, a client a server or any device that contains a processor and/or memory, whether that processor or memory performs a function related to an embodiment of the invention.

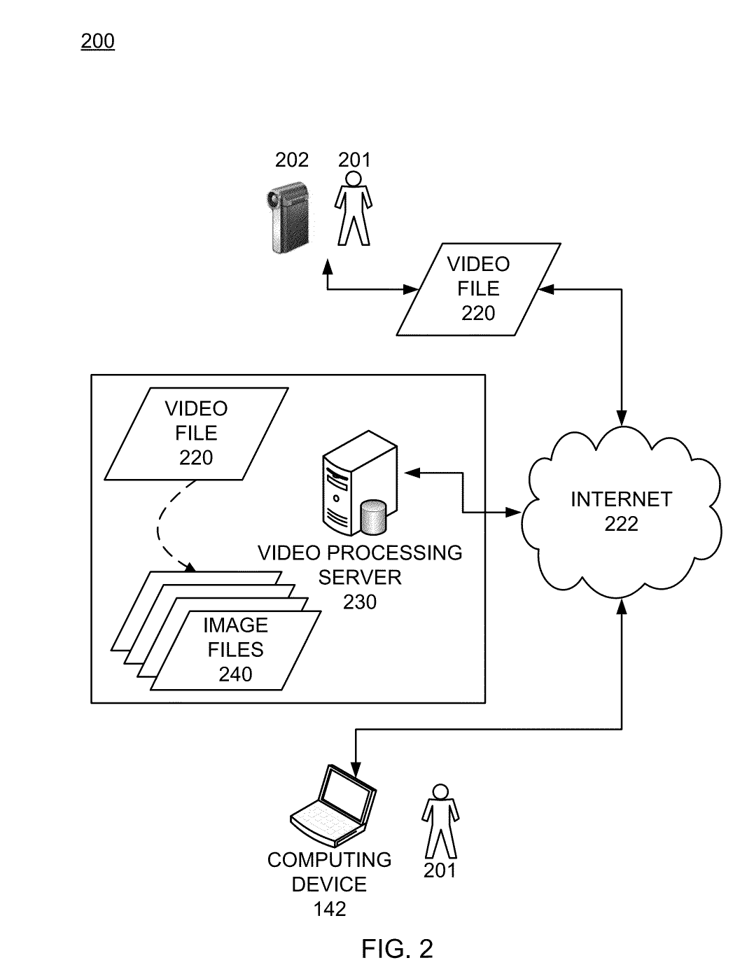

FIG. 2 illustrates an example communication network of video content being uploaded to a video processing server accessible by a user computing device. Referring to FIG. 2, a communication network 200 may include a user 201 operating a video camera 201 to capture a raw video which may be used to create a customized video and corresponding advertisement for presentation purposes as a video file, a website advertisement, a television advertisement, etc.

The video file 220 may be created as one single continuous shot of video footage or as a plurality of digital shots, which are shot as a series of start and stop videos operated by the user of the camera. The series of videos together may create one large video file 220. The video file may be transferred over the Internet 222 or locally via a firewire, HDMI or other interface cable to a video processing server 230.

The video processing server 230 may receive the video file(s) 220 and render it as multiple outputs files. One file may be a copy of the original video content, another file may be a reformatted video file of a different type but that still reflects the content of the original video file. Other files may be generated to depict still images based on the video content.

The digital video file 220 may be processed by the server 230 to separate the video data content into individual still images 240. There may be a very large number of images that can be produced from a video file. As a result, the application may extract and create a default number of digital still images. The digital image files 240 may be referred to as an image array of hundreds or even thousands of images that are based on the content of the video. In the case of an MPEG video, the images may be JPEG images. However, image file types may vary depending on the needs of the end user.

The user of the video processing application 201 may elect to have a default number of images for a particular video segment. The number of images extracted may be based on a predefined number of images extracted per a predefined time slot interval (e.g., 10, 20, 30, 40 photos extracted every ½, 1, 2, 3, 4 seconds, etc.). Alternatively, the number of photos may be based on an automated image processing function that seeks to maintain a certain amount of images for a given time frame (i.e., 200 photos for a one minute video). The user may access the processed content from his or her own computing device 142.

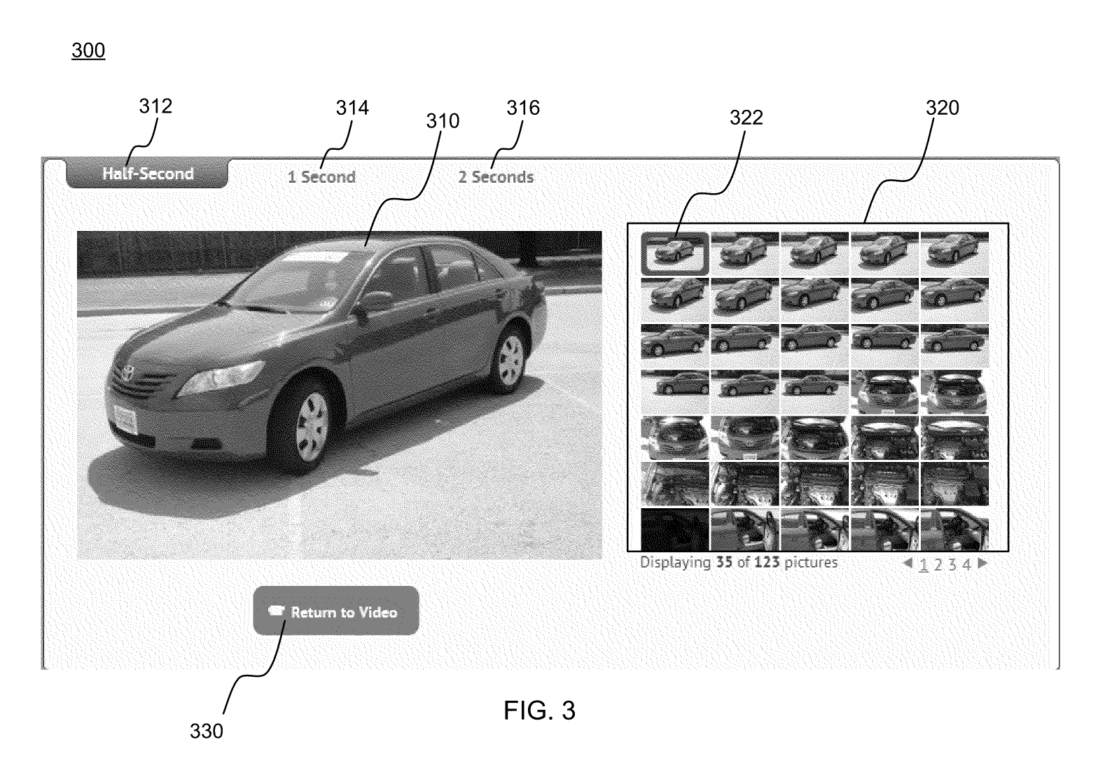

FIG. 3 illustrates an example graphical user interface of the video processing application according to example embodiments. Referring to FIG. 3, the graphical user interface 300 includes a section where one or more of the images may be displayed 310. The presently displayed image 322 is the first in a long list of images 322 that have been extracted from the processed video content. The image preview section enables a user to jump ahead in the displayed image or in the video itself by selecting the image of interest (i.e., “engine”) from the list of preview thumbnail images on the right. As a result, of making a particular selection, the user may jump ahead from the beginning image or video presentation to a later image or a later portion of the corresponding video playing on the image/video display area 310.

Certain options may be presented to the user of the GUI 300. For example, the half-second option 312, one-second option 314 and two-second option 316 each offer time intervals that would dictate how many photos are included in the preview section 320. For example, at a one-half second selection, a number of photos (i.e., 10) per time interval (one-half second) may be displayed for the entire video (i.e., 45 seconds). In this example 10 photos per half second over 45 seconds may yield as many as 45×10×2 photos. However, as the time interval lengthens and number of photos per time interval is reduced, the total number of still images per video will decrease. The different buttons and options 312, 314 and 316 offer a user with the capability to display different photo groups and go back-and-forth until one is considered satisfactory. Once, a total number of images is selected by the user, the user may then begin selecting, de-selecting, deleting, adding, etc., the images to create a queue of images that are presentable during the advertisement video. For instance, images, that are blurred, dark, repetitive, etc., may be removed from the list. Others, may be selected as insertion points for words, audio, transitions, etc., so the images can then be rendered back into a final output new video format.

Each of the advertisement requests transmitted to the server 230 may be in a request queue or may be processed in real-time or near real-time. The images are stored in the server 230 as well as various different types of metadata (height, width, file size, etc.). The images may be associated with the video. The user may then receive a notification message that the images are ready and for observation, which allows the user to make changes before fully approving the output video and advertisement data. The image removal and selection operations may be performed automatically. For example, a digital filter may calculate a weight of the images and if the color weight of the pixels or a weight of a certain percentage of the pixels indicates that they are too dark or too light, the processor may remove those images or place them in a discard memory location where the user may still review and confirm the image removal operations of the automated system.

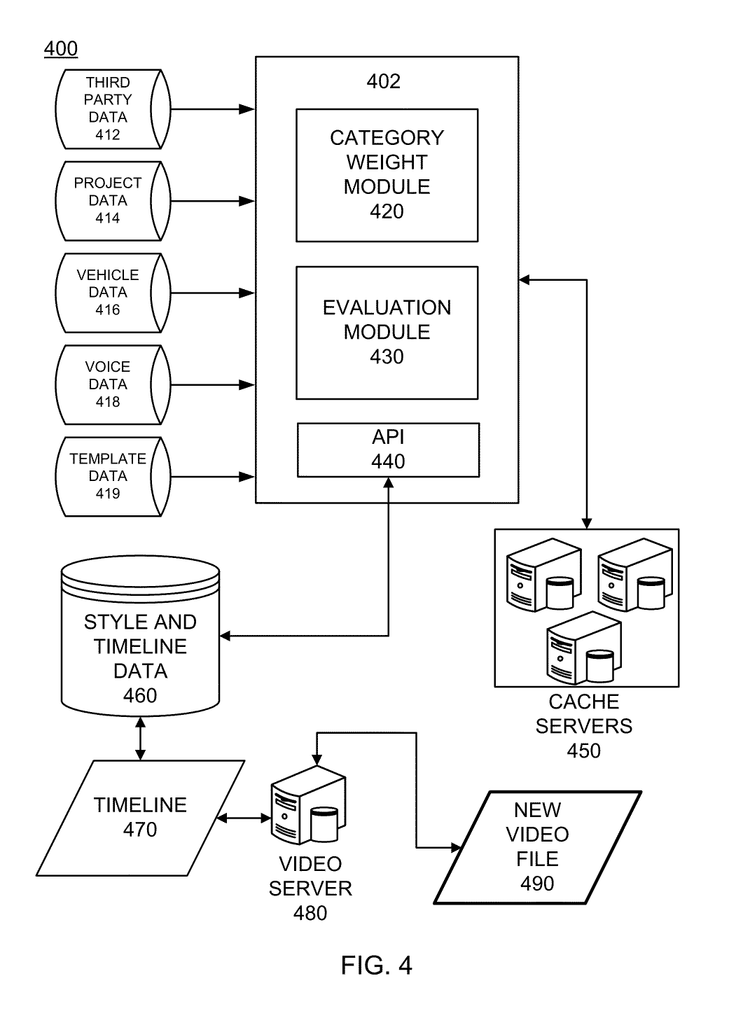

FIG. 4 illustrates an example video processing system used to integrate the various data inputs associated with the example product, according to example embodiments. Referring to FIG. 4, the system 400 includes a process logic that is operated by one or more processors of one or more data servers. In operation, various different types of data may be received from various different data sources. The data may be received by a data processing module 402, which includes a category weight module 420, an evaluation module 430 and an application programming interface (API) 440.

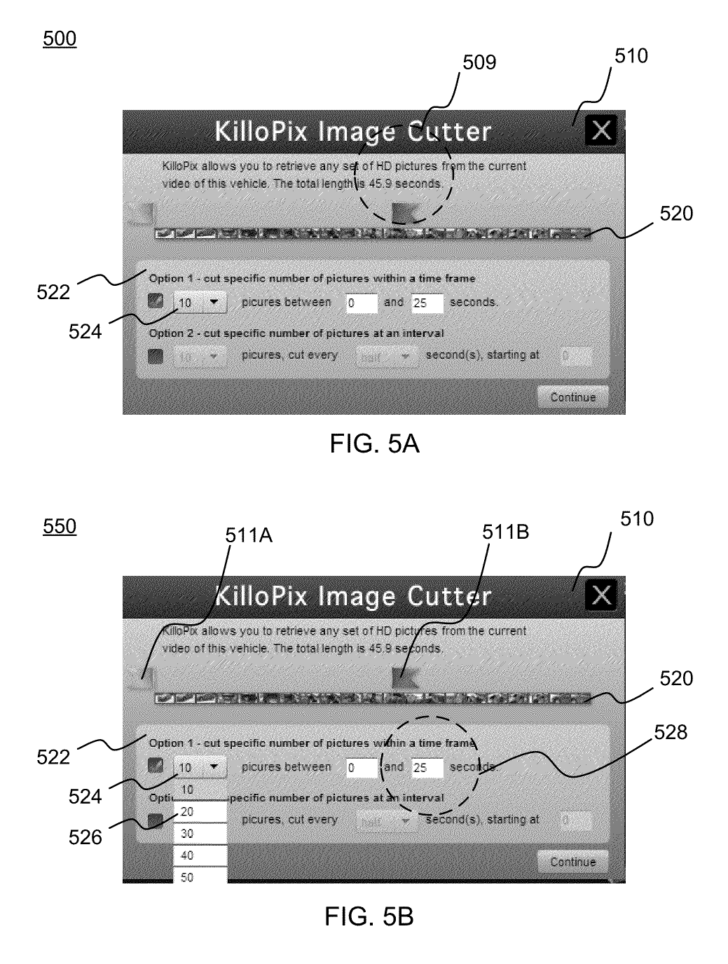

In operation, the data sources may provide certain types of data, such as third party data 412, project data 414, vehicle data 416, voice data 418, and/or template data 419. The third party data 412 may include information about a particular car for sale, such as a CARFAX® report, or a NADA® price list of vehicle prices to be incorporated with the other content of the advertisement. The project data 414 may include the actual raw video feed provided by the user of the car's appearance and interior. Vehicle data 416 may include generic vehicle data, such as make, model, year, original MSRP price, engine size, manufacturer's information, warranty, performance statistics, engine data, etc. The voice data 418 may be voice-over data provided during the video, voice data stored in a database, that identifies the vehicle, the dealer, the car's specifications, etc. The voice data may be inserted onto a video feed at specified locations, as discussed in greater detail below. Also, template data 419 provides a predefined template for an output and editing configuration, such as those illustrated in the GUIS of FIGS. 3, 5A, and 5B.

The category weight module 420 may identify the various different data segments and weigh certain ones over others to create a priority listing of data that should be included in the outputted advertisement. Certain data that is not weighted or is weighted lowly may be disregarded or ignored during a data population procedure of the data template. For example, car specifications may include an abundant amount of information regarding a particular make and model of a car or other motor vehicle. However, engine specifications, miles-per-gallon, acceleration and related figures may be weighted higher than other specifications to increase the likelihood of end user satisfaction with an otherwise limited advertisement time and/or viewing space.

Once the data is weighed, the evaluation module 430 may process the various different data sources to confirm they are accurate and are going to fit into a particular template for presentation purposes. The cache servers 450 may include one or more servers that are operating together to store, retrieve and/or update the various content received from the data sources. As the information is updated or received, it may be retrieved, deleted, and/or uploaded to the cache servers 450. Once the received data is organized, weighted, parsed for accurate relevancy and setup for delivery to the end user, the data may be linked to an application programming interface (API) 440 tied to a user portal or application accessible via the user's computing device. The API allows the user to make updates and approve or disapprove of certain changes to the overall content and appearance of the advertisement.

A style and timeline data source 460 may be used to store the particular output style of the template and the corresponding timeline structure of the video data so the user may be able to identify, modify and/or approve the data included in the timeline 470 provided to the user. As changes are made to the number of images, the corresponding inputted data including, text, audio, transitions, etc., the timeline 470 may be updated and stored in the data source 460 for easy retrieval. Examples of image processing options may include an image cutter feature, which allows the user to pause the video and create a starting point or transition point. The user may then press ‘play’ and then ‘pause’ again which becomes an automatically inserted stopping point in the image list and/or video stream. The changes may be saved and linked to the master video stream object.

The image and video data accessible by a viewer, editing user or other end user may be stored in the application processing video server 480, which receives the feedback and editing options and ultimately generates and renders a new video file 490 based on all the submitted data and modifications provided. The final video file 490 may be inserted into the advertisement template and may be the basis for which images are provided to the viewer for viewing, fast-forwarding and all of the end user viewing and interaction options.

FIG. 5A illustrates an example graphical user interface for customizing a video stream as an array of images according to example embodiments. Referring to FIG. 5A, the user interface 500 includes a display window 510 including a timeline 520 of the images included in the video. A total length of the video is identified as being 45.9 seconds (see identifier 509) of which includes hundreds of images on a single timeline. A few user options are provided in display window 522, which includes option one ‘1’ to “cut specific number of pictures within a time frame, such as 0-25 seconds. Or option ‘2’, cut a specific number of pictures at a particular time interval repeating throughout the entire video. In FIG. 5A, the option ‘1’ is selected and the default number 524 of pictures is 10 for a 25 second time interval.

In FIG. 5B, the option ‘1’ of GUI 550 is also selected except the drop down list has been selected to include various different image numbers (e.g., 10, 20, 30, 40 and 50) 526 for a predetermined time frame. Also, identifier 528 illustrates a time frame of 0-25 seconds during which the number of images selected will be extracted. Also in FIG. 5B, the start flag 511A and the stop flag 511B are illustrated as having been set to the middle area of the video timeline 520, the stop flag 511B indicates the 25 second mark of an otherwise 45.9 second video.

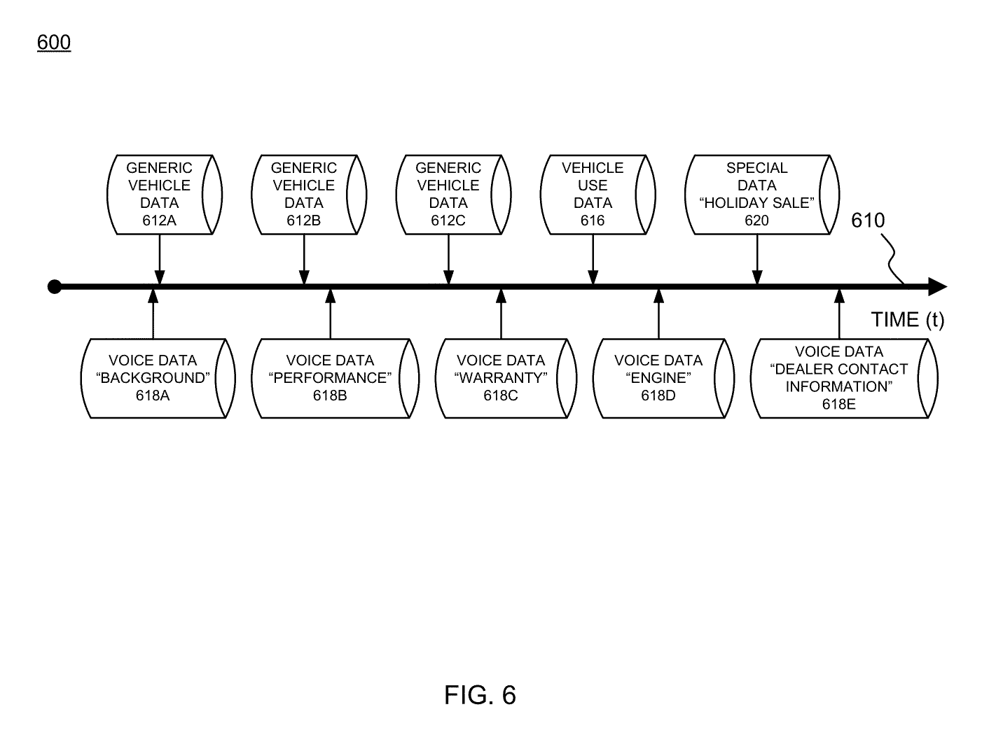

According to other example embodiments, the timeline of video/image content may be customized by adding certain data entries, overlays, tie-ins and other data styles to an existing timeline of video content. FIG. 6 illustrates an example video timeline configured to receive data inserts at specified time insertion points according to example embodiments.

Referring to FIG. 6, a full motion video 600 may be set as a timeline 610 that includes various data inserts, tags, overlays and other data formatting identifiers. In FIG. 6, the timeline 610 may be tagged to include various identifiers of a car video sample provided by a user. Examples of such tags may include portions of the video identifying certain car angles, and other specific car information, such as a “trunk”, “left side”, “right side”, “driver's side”, “passenger side”, “front”, “interior”, etc. Those tags may be inserted into the video by an image tagging operation performed prior to the video being converted to video. The tags may provide pointers to have certain generic information provided as part of the video timeline. For example, generic vehicle data 612A may be a short introduction to the make, model and engine size, generic vehicle data 612B may be a short introduction to other parts of the car, or is performance and statistics, while generic vehicle data 612C may be directed to the car's mile per gallons and present consumer rating. The actual video footage that takes place during the generic vehicle data insertions may include a panning of the front, right, rear and left side of the vehicle.

Specific vehicle use data 616, such as a CARFAX® report may then be presented as a video overlay or as a textual insert alongside the video display of the live footage of the car's exterior surface. Other examples may be a KELLY BLUE BOOK KBB® report on market price or other useful data a potential buyer may find interesting. Thereafter, a pre-recorded dealer specific sale including a holiday banner insert, footage of Winter and presents for the holidays, a Turkey for Thanksgiving, etc. may be overlaid or inserted into the timeline to grab the viewer's attention that it a holiday sale is happening with respect to the sale of the vehicle in the video.

In addition to textual and video inserts, an audio track may be modified or laid for the course of the video timeline. A voice narrative that matches the tagged portions of the video timeline may be provided to match the course of the video. For example, as the wide-angle shots of the vehicle are displayed, a basic background 618A may be provided to describe the make, model and key features of the vehicle. As a tag is presented that the video is now illustrating the tires or front of the car, then a performance audio segment 618B may begin that describes the vehicle's driving performance and miles-per-gallon. As the tag for the rear of the car is illustrated, a description of the manufacturer's and/or dealer's warranty 618C may be presented in the video. As a shot of the engine is presented, certain characteristics of the engine 618D may then begin playing as audible content. Lastly, as the final seconds of the video are playing, the dealer contact information 618E and known slogans, and songs may begin playing to attract customers to the dealer to buy the displayed vehicle.

As may be observed, various different video, audio and textual information ordering scenarios are possible and may be customized to accommodate the user's preferences. Also, within the video, other metadata may be inserted, such as global position (GPS) data, which may be used to confirm a vehicle's location or a home that is for sale in the case of a real estate home sale advertisement. Such GPS data may be used to automatically identify an address which is correlated with an address databank.

The present image and video production application of the present application provides a user with the capability to go to any chapter, section or display image of an otherwise larger image array and view any part of the video or photo(s). Synchronization of the images and/or dynamic reordering of images may be performed based on geospatial data that is obtained and associated with the images or video content.

The image and video processing application may automatically select an image every ‘x’ seconds from the video and create still images as a result. The application may also indicate that the total number of images can be adjusted by moving back or forward to a next image. As a result, the image array also provides an easy interface to add or interlace other videos, photos, within the current video/image chain. Tagging may be performed to the images by verbally tagging the images during the video shoot or afterwards. For example, when an image array is created, the user may identify each change in vehicle position to be a new or different set of images. Image recognition software may also be used to identify when interior images of the vehicle have stopped and/or started. This may be helpful in removing portions of an image array, for example, removing pictures of the roof which are normally not required by vehicle sales advertisements.

Third party data about the car may be received by the same databank that stores the video content. For example, data about the object (car), such as make, model, year, VIN, color, price, installed options, trim, engine specifications, etc., and use this third party data and the corresponding images of the car provided by a user, or stock photos, and put together a video based on the images, the audio, the other content, etc. In this example, there is no video used to generate a video only other forms of data that together create a video and audio bearing video output.

In the event of multiple videos, a user can shoot many different videos by walking around the car and stopping and starting the video shooting functions repeatedly. Thereafter, the user tags these different videos by selected options, spoken audio or other tagging procedures and may perform any one of the following operations, including rendering a video by using the original video content and a different source of audio, using the original video and the user's own voice or creating a short video introduction and reusing that voice repeatedly for various different videos (e.g., “4th of July sale, come on down!”).

A template may be used with the video to provide a banner (i.e., “Toyota Dealership”) which can change to show a dealer name, that a car is certified, etc., and the text can be shown to include other information, such as the make, model, year, price, etc. The textual information may be shown in the video, for example, by providing a number of miles as clear video overlay or as a separate window indicator during the dashboard being displayed on the video.

Based on the video segment that is provided (e.g., engine, exterior, etc.) and marked/tagged accordingly, “engine”, the system will provide the text and/or voice that goes along with that specific video by utilizing synchronization. For example, the video may be time-shifted, slowed down or sped-up to “fit” the text/voice description (i.e., matching images of the engine with audio about the vehicle engine). If the present synchronization is outside of a particular threshold (2 seconds or more), then a particular action may be taken to re-synchronize the video with the inserted audio description. One example may include removing a certain amount of images (e.g., 10, 20, 30 images) by default to shrink the timeline of video content to align the video with the particular description. Alternatively, the number of images may instead by increased by adding a predetermined number of images of particular topic to increase the video content display time of a particular video segment and align the correct audio with the correct video. If video is longer than the corresponding audio narrative, then slowing down the video by increasing a dwell time of one or images may be appropriate to perform the needed time-shifting. Other alternatives may include cropping one or more images by reducing the last second or seconds of a segment or placing an audible spacer, music, a pause in the video and/or audio, etc. Or, you can do nothing and include music or other information that is not part of the narrative, but which is instead related to the video or to the dealership in general. If the video is shorter than the narrative audio portion, a loop of the video may be performed to play the video more than once, or time-shifting of the video may be performed to slow the video to catch up to the narrative audio. Also other visual assets may be brought into the video, such as advertisements or other relevant information.

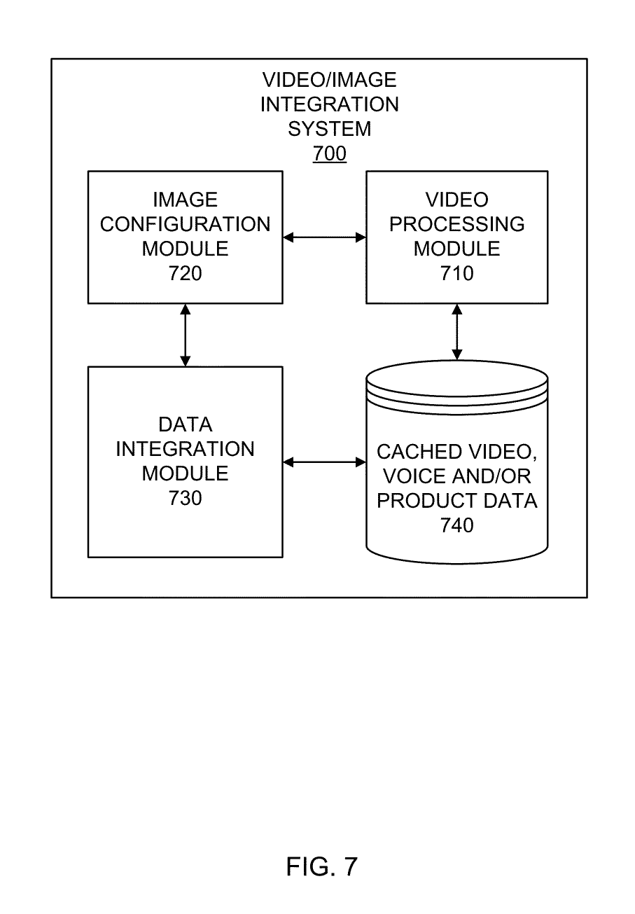

FIG. 7 illustrates an example single-entity or multiple entity system diagram of an image/video processing system that performs the various operations and features corresponding to the example embodiments. The system 700 of FIG. 7 may perform a method of processing a digital video by uploading/receiving a digital video at an application processing device and processing the digital video to extract an array of digital images via a video processing module 710. The array of digital images may be displayed on a user interface of a display of the application processing device via the image configuration module 720 which may also perform modifying at least one of the digital images of the array of digital images to remove, add, change or modify the digital image(s). The finalized output of the digital images may be rendered into a new digital video that is based on the modified digital images and the added additional data via the data integration module 730.

According to one example, the process of adding additional data may be performed as a video overlay that is added to the array of digital images. The modifying of the digital images of the array of digital images may include removing at least one of the digital images from the array of digital images that are stored in the cached video, voice and/or product data 740. The cached data 740 may also store metadata associated with one or more of the array of images, the metadata may identify certain image characteristics, such as image dimensions, image type, a pause point, and an association identifier corresponding to the specific content of the image. An example association identifier may be a specific image item, such as a car trunk, a car tire, a car interior, etc. The association identifier is essentially based on product information of a product included in the image. The data integration module 730 may also identify at least one pause point in the digital video by identifying one or more of the digital images within the array of digital images as having the pause point included in its metadata. The pause point may be created in a video stream associated with the new digital video based on the identified pause point prior to rendering the new digital video. The plurality of the digital images may be identified as having a corresponding plurality of pause points and multiple pause points may be inserted in the video stream based on the plurality of pause points identified via the image configuration module 720. Also, the number of digital images to be extracted per a selected unit of time of the digital video may be specified, and an array of digital images may be created based on the selected number of digital images per the selected unit of time.

The system of FIG. 7 may also perform another example type of operation for creating a customized advertisement for a particular product. In this example, the system 700 may receive product use information related to prior use of the product, such as a CARFAX® report, and a digital video including footage of the particular product, and also receive generic product information related to manufacturer specifications of the product. The information may be stored in the cached data 740. The system may also perform processing the product use information, the digital video and the generic product information to create the customized advertisement via the video processing module 710. The system 700 may also transmit the customized advertisement to a remote computing device so a user may view the various data in one GUI, via the data integration module 730.

The product information related to the specifications of the product comprises may be based on updated history product use information of the exact product identified in the digital video. The digital video may be various different digital videos each including footage of the particular product. The system 700 may also perform identifying a plurality of tags associated with the multiple different digital videos, including various metadata included in the plurality of different digital videos. The metadata of each of the plurality of digital videos identifies a portion of the product that is being identified by each of the corresponding plurality of digital videos.

The system may further provide retrieving the generic product information that corresponds to each of the plurality of tags from the product data cache 740 and inserting audio information and/or text information into the customized advertisement at a synchronized insertion point corresponding to each of the plurality of tags and associated with a particular time slot of the digital video via the data integration module 730. The system 700 may also include time-shifting the digital video to correspond to the inserted audio information and the text information and rendering the digital video to synchronize a portion of the video with the inserted at least one of the audio information and the text information via the data integration module 730. The audio information and the text information provide manufacturing details of a particular portion of the product at the synchronized portion of the video that is displaying the particular portion of the product.

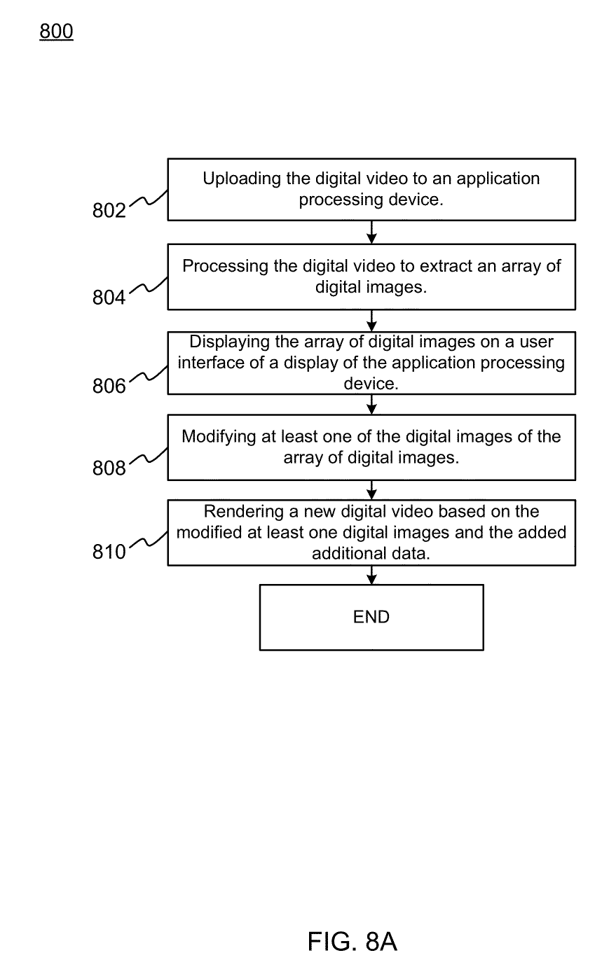

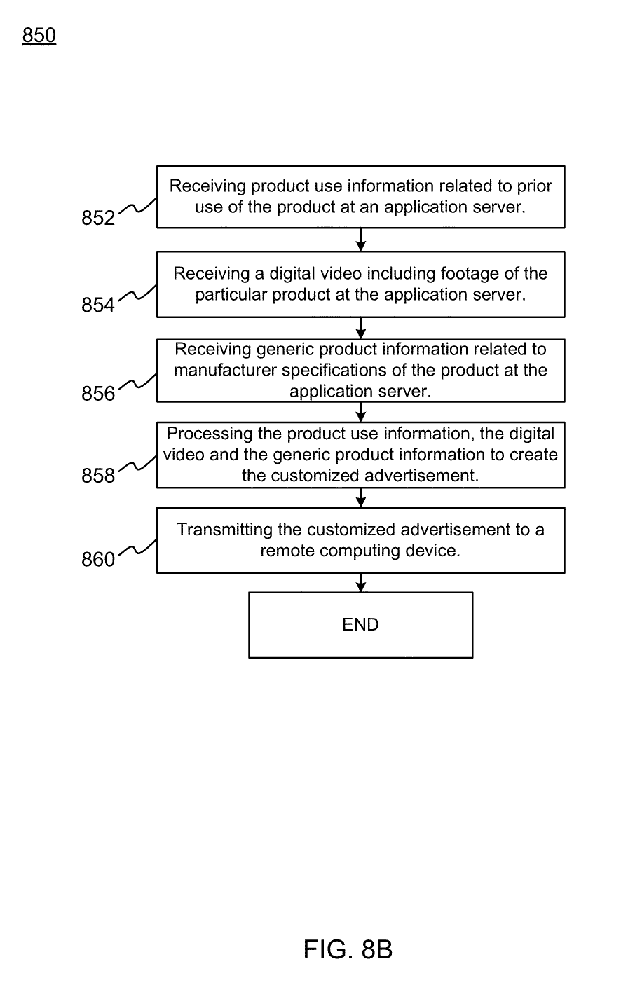

One example method of operation is illustrated in the flow diagram of FIG. 8A. Referring to FIG. 8A, the flow diagram 800 illustrates a method of processing a digital video. The method may provide uploading the digital video to an application processing device, at operation 802, and processing the digital video to extract an array of digital images, at operation 804. The method may also provide displaying the array of digital images on a user interface of a display of the application processing device, at operation 806 and modifying at least one of the digital images of the array of digital images, at operation 808. The method may further include rendering a new digital video based on the modified at least one digital image and the added additional data at operation 810.

Another example method of operation is illustrated in the flow diagram of FIG. 8B. Referring to FIG. 8B, the flow diagram 850 illustrates a method of creating a customized advertisement for a particular product. The method may include receiving product use information related to prior use of the product at an application server, at operation 852 and receiving a digital video including footage of the particular product at the application server, at operation 854. The method may include receiving generic product information related to manufacturer specifications of the product at the application server, at operation 856, and processing the product use information, the digital video and the generic product information to create the customized advertisement, at operation 858. The method may also include transmitting the customized advertisement to a remote computing device, at operation 860.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

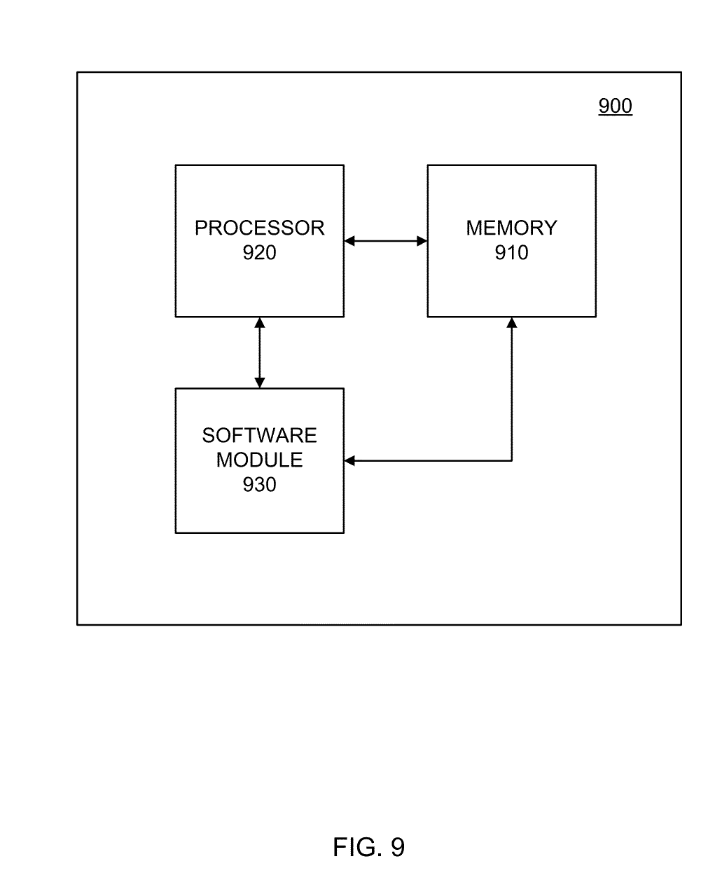

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 9 illustrates an example network element 900, which may represent any of the above-described network components of the other figures.

As illustrated in FIG. 9, a memory 910 and a processor 920 may be discrete components of the network entity 900 that are used to execute an application or set of operations. The application may be coded in software in a computer language understood by the processor 920, and stored in a computer readable medium, such as, the memory 910. Furthermore, a software module 930 may be another discrete entity that is part of the network entity 900, and which contains software instructions that may be executed by the processor 920. In addition to the above noted components of the network entity 900, the network entity 900 may also have a transmitter and receiver pair configured to receive and transmit communication signals (not shown).

Although an exemplary embodiment of the system, method, and non-transitory computer readable medium of the present application has been illustrated in the accompanied drawings and described in the foregoing detailed description, it will be understood that the present application is not limited to the embodiments disclosed, but is capable of numerous rearrangements, modifications, and substitutions without departing from the spirit or scope of the application as set forth and defined by the following claims. For example, the capabilities of the system illustrated in FIG. 3 may be performed by one or more of the modules or components described herein or in a distributed architecture. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method of creating a customized advertisement for a particular product, the method comprising:
receiving product use information related to prior use of the product at an application server;
receiving a digital video including footage of the particular product at the application server;
receiving generic product information related to manufacturer specifications of the product at the application server;
processing the product use information, the digital video and the generic product information to create the customized advertisement; and
transmitting the customized advertisement to a remote computing device.

2. The method of claim 1, wherein receiving product information related to the specifications of the product comprises receiving updated history product use information of the exact product identified in the digital video.

3. The method of claim 1, wherein receiving a digital video including footage of the particular product at the application server comprises receiving multiple different digital videos each including footage of the particular product.

4. The method of claim 3, further comprising:
identifying a plurality of tags associated with the multiple different digital videos, wherein the plurality of tags are metadata included in the plurality of different digital videos, and wherein the metadata of each of the plurality of digital videos identifies a portion of the product that is being identified by each of the corresponding plurality of digital videos.

5. The method of claim 4, further comprising:
retrieving the generic product information that corresponds to each of the plurality of tags; and
inserting at least one of audio information and text information into the customized advertisement at a synchronized insertion point corresponding to each of the plurality of tags and associated with a particular time slot of the digital video.

6. The method of claim 5, further comprising:
time-shifting the digital video to correspond to the inserted at least one of the audio information and the text information; and
rendering the digital video to synchronize a portion of the video with the inserted at least one of the audio information and the text information.

7. The method of claim 6, wherein the audio information and the text information provide manufacturing details of a particular portion of the product at the synchronized portion of the video that is displaying the particular portion of the product.

8. An apparatus configured to create a customized advertisement for a particular product, the apparatus comprising:
a receiver configured to
receive product use information related to prior use of the product at an application server,
receive a digital video including footage of the particular product at the application server,
receive generic product information related to manufacturer specifications of the product at the application server;
a processor configured to process the product use information, the digital video and the generic product information to create the customized advertisement; and
a transmitter configured to transmit the customized advertisement to a remote computing device.

9. The apparatus of claim 8, wherein the product information related to the specifications of the product comprises updated history product use information of the exact product identified in the digital video.

10. The apparatus of claim 8, wherein the digital video including footage of the particular product received at the application server comprises multiple different digital videos each including footage of the particular product.

11. The apparatus of claim 10, wherein the processor is further configured to identify a plurality of tags associated with the multiple different digital videos, wherein the plurality of tags are metadata included in the plurality of different digital videos, and wherein the metadata of each of the plurality of digital videos identifies a portion of the product that is being identified by each of the corresponding plurality of digital videos.

12. The apparatus of claim 11, wherein the processor is further configured to retrieve the generic product information that corresponds to each of the plurality of tags, and insert at least one of audio information and text information into the customized advertisement at a synchronized insertion point corresponding to each of the plurality of tags and associated with a particular time slot of the digital video.

13. The apparatus of claim 12, wherein the processor is further configured to time-shift the digital video to correspond to the inserted at least one of the audio information and the text information, and render the digital video to synchronize a portion of the video with the inserted at least one of the audio information and the text information.

14. The apparatus of claim 13, wherein the audio information and the text information provide manufacturing details of a particular portion of the product at the synchronized portion of the video that is displaying the particular portion of the product.

15. A non-transitory computer readable storage medium configured to store instructions that when executed cause a processor to perform creating a customized advertisement for a particular product, the processor being further configured to perform:
receiving product use information related to prior use of the product at an application server;
receiving a digital video including footage of the particular product at the application server;
receiving generic product information related to manufacturer specifications of the product at the application server;
processing the product use information, the digital video and the generic product information to create the customized advertisement; and
transmitting the customized advertisement to a remote computing device.

16. The non-transitory computer readable storage medium of claim 15, wherein receiving product information related to the specifications of the product comprises receiving updated history product use information of the exact product identified in the digital video.

17. The non-transitory computer readable storage medium of claim 15, wherein receiving a digital video including footage of the particular product at the application server comprises receiving multiple different digital videos each including footage of the particular product.

18. The non-transitory computer readable storage medium of claim 17, wherein the processor is further configured to perform:
identifying a plurality of tags associated with the multiple different digital videos, wherein the plurality of tags are metadata included in the plurality of different digital videos, and wherein the metadata of each of the plurality of digital videos identifies a portion of the product that is being identified by each of the corresponding plurality of digital videos.

19. The non-transitory computer readable storage medium of claim 18, wherein the processor is further configured to perform:
retrieving the generic product information that corresponds to each of the plurality of tags; and
inserting at least one of audio information and text information into the customized advertisement at a synchronized insertion point corresponding to each of the plurality of tags and associated with a particular time slot of the digital video.

20. The non-transitory computer readable storage medium of claim 19, wherein the processor is further configured to perform:
time-shifting the digital video to correspond to the inserted at least one of the audio information and the text information; and
rendering the digital video to synchronize a portion of the video with the inserted at least one of the audio information and the text information, and wherein the audio information and the text information provide manufacturing details of a particular portion of the product at the synchronized portion of the video that is displaying the particular portion of the product.
